(19) United States
(12) Patent Application Publication
(10) Pub. No.: US 2005/0242030 A1
(43) Pub. Date: Nov. 3, 2005

(54) Device and process for membrane electrophoresis and electrofiltration

(75) Inventors: Ralf Lausch, Gottingen (DE); Oscar-Werner Reif, Gottingen (DE); Ulrich Grummert, Bad Soden Allendorf (DE); Stefan Haufe, Gottingen (DE); Holger Linne, Gottingen (DE); Andre Pastor, Gottigen (DE); Gregor Dudziak, Oakland, CA (US); Andreas Nickel, Wetter (DE); Martina Mutter, Koln (DE); Michael Traving, Leverkusen (DE)

Correspondence Address: Kurt G. Briscoe;Norris, McLauglin & Marcus P.A., 18th Floor, 875 Third Avenue, New York, NY, 10022, US

(73) Assignee: Bayer Technology Services GmbH, Leverkusen (DE)

(21) Appl. No.: 11/054,760

(22) Filed: Feb. 10, 2005

(30) Foreign Application Priority Data
Feb. 17, 2004 (DE) 1020040078483

(51) Int. Cl. B01D 61/42

(52) U.S. Cl. 210/639; 210/650; 210/243; 204/518; 204/450

(57) ABSTRACT

A device and a process are described for membrane electrophoresis or electrofiltration. The device contains at least one input chamber, one output chamber, and one cathode chamber and anode chamber each, whereby the individual chambers are separated from one another by membranes, and are integrated into a permanently attached module with membranes, and whereby the electrodes are integrated into the module, and the module is connected to constructions enabling continuous flow through the input and output chambers, as well as through the electrode chambers. It is emphasized that this abstract is provided to comply with the rules requiring an abstract which will allow a searcher or other reader quickly to ascertain the subject matter of the technical disclosure. It is submitted with the understanding that it will not be used to interpret or limit the scope or meaning of the appended issued claims. 37 CFR §1.72(b).

The invention concerns a device and a process for membrane electrophoresis and electrofiltration. The device contains a module, which is permanently attached.

In the case of membrane electrophoresis, semi-permeable membranes usually work as convection barriers between two adjacent separation channels, in which at least one loosened or dispersed component can migrate from one channel to the other under the effect of an electric field.

In earlier publications on membrane electrophoresis (DE 3 337 669-A2, U.S. Pat. No. 4,043,896, U.S. Pat. No. 6,328,869), electrophoresis devices were described, which must be assembled manually. The modules, consisting of flat membranes, frame gaskets, and possibly netting, are stretched in stentering frames and sealed with screws. The stentering frames contain inlets and outlets for concentrate, diluate, and electrodes, as well as one electrode each.

This construction, which is also used in electrodialysis, offers the benefit of great flexibility, since the membranes can be individually exchanged, if needed. However, manual module assembly is a very time-consuming process on an industrial scale. In addition, the manufacturer cannot perform any integrity or impermeability tests on the device. These tests can only be performed by the user after assembling the individual components.

When manually assembling such modules, especially on an industrial scale, there are relatively large deviations with regard to centring membranes and spacers. This leads to unequal pressure losses in distribution channels connected in parallel, and thus to locally different overflow speeds, and dead zones in extreme cases.

Non-ideal flow management in the module decreases the selectivity and productivity of a separation procedure.

Normally, liquid films form in such devices between seals and membranes, which leads to leakage in the module, especially at high overflow speeds and increased pressure.

Customary overflow speeds in the operation of the previously described manually constructed modules are in the range of 0.1 m/s (Galier et al., J. Membrane Sci 194 [2001] 117-133, U.S. Pat. No. 5,087,338).

However, in the case of membrane electrophoresis, higher overflow speeds can be necessary, especially with high solvate concentrations. An overflow speed, that is too low leads to concentration polarization in the membrane. In extreme cases, product sediment forms on the membranes.

Dependable sterilization, e.g. with sodium hydroxide, is made considerably more difficult by dead spaces in the area of the seal in customary devices. It is not possible to steam-sterilize such a module at 120° C., due to the increased pressure and resulting leakages. Therefore, the customary modules are only reusable to a limited degree.

The previously described disadvantages of the typical constructions occur even on a small scale, and they increase on a larger scale.

Cassette modules are the state-of-the-art for cross-flow filtration. In general, several cassette modules are arranged in series. The cassette modules are pressed between clamping plates at their edges. The clamping plates are equipped as inflow or outflow plates with corresponding distributors and connections to the channels for fluid inflow, retentate outflow, and permeate outflow.

In cross-flow filtration, the fluid to be filtered is pushed through distribution channels into the overflow gaps of the filter cassette for the fluid being filtered. It overflows the membrane surfaces and flows off as retentate. A portion permeates through the membrane, is collected, and is drained out of the equipment as permeate through the corresponding channels and outflow plate. The fluid flows and pressures are regulated by pumps and valves. Cross-flow filter cassettes are described in patents U.S. Pat. No. 4,715,955 and DE 3 441 249-A2, for example.

In the case of electrofiltration, both a pressure differential as in cross-flow filtration, and an electric field as in membrane electrophoresis, are used as driving forces for the separation process. The fluid to be separated flows through the retentate chamber and partially permeates a semi-permeable membrane. By overlaying an electric field orthogonally to the membrane, the selectivity of the separation can be considerably increased.

The electrofiltration devices described up to this point correspond to the state-of-the-art of the devices for membrane electrophoresis with respect to their construction. As with those devices, manually constructed modules are described, consisting of flat membranes, frame gaskets, and possibly netting, which are stretched in stentering frames and sealed with screws. The stentering frames can contain inlets and outlets for retentate, permeate, and electrode chambers, as well as one electrode each.

On one hand, modules are described, which have inlets and outlets for the retentate chamber, but only an outlet for the permeate chamber (U.S. Pat. No. 3,079,318). On the other hand, modules are described in which both flows can be re-circulated by inlets and outlets in the retentate and permeate chambers (U.S. Pat. No. 4,043,896).

Since the electrofiltration devices described up to this point exhibit the same weak points as the electrophoresis devices, the same problems can be observed with this process, particularly with regard to testing, re-use, and use on a large scale.

In summary, membrane electrophoresis and electrofiltration are referred to as electrophoretic separation processes.

The basis of this invention is the problem of developing an optimized, scaleable device for industrial membrane electrophoresis and industrial electrofiltration, which contains a module that can already be tested for impermeability after manufacturing, i.e. at the place of manufacture, at least with respect to the input and output chambers. Input chambers are defined as the chambers through which the mixture to be separated flows. Output chambers designate the chambers, which take in components that have permeated through the separation membrane.

In addition, the membrane integrity of the installed membrane sections and the functionality of the module should be testable.

In addition, the device must be able to be sterilized with sodium hydroxide and/or steam at a minimum of 120° C.

The module should be easy to exchange and exhibit a minimum of dead volume.

The module should be able to be operated at an overflow speed of up to 1 m/s.

The module should particularly contain several input chambers and output chambers in alternating order, connected in parallel, which are formed by sufficiently centralized membranes and spacers, which guarantees a reproducible and uniform pressure-drop in all channels and a uniform distribution of liquid flow in channels connected in parallel.

The productivity and/or selectivity of electrophoretic separation processes should be increased through the use of the new type of module, as compared with the use of customary, exclusively manually assembled modules.

The device should be constructed in such a way that several modules can be connected in series and/or in parallel in order to save space.

When the device is operated for membrane electrophoresis, the input chambers are designated as diluate chambers, and the output chambers are designated as concentrate chambers.

When the device is operated for electrofiltration, the input chambers are designated as retentate chambers, and the output chambers are designated as permeate chambers.

Now a device to be used for membrane electrophoresis and electrofiltration has been invented, which contains at least one input chamber and one output chamber, as well as one anode chamber and one cathode chamber. A separation membrane separates the input chamber and output chamber. The input and output chambers are separated from the electrode chambers by way of a restriction membrane. Electrodes are integrated in the anode chamber and the cathode chamber. At least the input chambers and output chambers are permanently integrated into a module by welding or gluing the membranes to spacers and frame gaskets. In this way, the complete module can be produced in one piece and already be tested for impermeability, membrane integrity, and functionality at the manufacturing site.

In addition, good sterilizability, and reusability are achieved by minimizing the dead space in the module, and by welding or gluing the frame gaskets to the membranes.

Centring and permanently affixing the membranes and spacers at the manufacturing location optimizes the fluid distribution, which enables the selectivity and productivity of separation processes to-be optimized as well.

The abovementioned problems are solved in a surprisingly simple and efficient manner by this device.

The subject of this invention is therefore a device for membrane electrophoresis or electrofiltration, containing at least a first holding plate, a first electrode chamber with an electrode, at least one input and output chamber, a second electrode chamber with electrode, and a second holding plate, in which the chambers are separated from each other by flat membrane sections, and in which at least the edges of the membranes are integrated into a sealing frame located in a permanently attached module. The sealing frame possesses channels for the inflow and outflow of liquids with holes leading off the channels into selected chambers. In at least one of the holding plates there are connecting channels, which correspond to the respective channels in the sealing frame.

In the module, which corresponds to the invention, several input and output chambers can be arranged in alternating order. The input chambers and output chambers are preferably connected in parallel.

In one particular embodiment of the invention, the membranes, separation membranes, and restriction membranes used in the module are shown arranged in alternating order. Particularly significant is that the number of restriction membranes is one more than the number of separation membranes, i.e. if the number of separation membranes is equal to n, where n is a whole number, then the number of restriction membranes is equal to n+l.

In the module described above, the electrodes can either be integrated into independent electrode modules or into the module holding plates. Alternatively, a combination of the abovementioned configurations can be chosen, in which only the anode is integrated into the separation module, and the cathode is either integrated into a separate module or a module holding plate. Such a configuration is economical if the attainable operating times for membranes, cathodes, and/or anodes considerably differ from one another, for example.

In another embodiment of the device, both electrodes and holding plates can be integrated into the separation module. The holding plates contain inlets and outlets for input and output chambers, as well as for the electrode chambers.

It is preferable to hold the invention and its components, such as holding plates and modules, together in a leak-proof manner by using contact pressure at the edges.

The sealing frame preferably has a radial or axial projection over the flat membranes, particularly an axial projection of less than 100 μm, which forms a peripheral edge seal through contact pressure.

The base material of the module is chosen in such a way that the module can be sterilized. The sterilization can either be performed with sodium hydroxide or steam (120° C.). The following are used as base materials for the module: polycarbonate, polyvinylchloride, polysulphone or other plastics/polymers, where thermoplastics are preferred such as e.g. ETFE (ethylene/tetrafluoroethylene), ECTFE (ethylene/chlorotrifluoroethylene), PP (polypropylene), PFEP (tetrafluoroethylene/hexa-fluoropropylene), PFA (perfluoroalkoxy-copolymer), PVDF (polyvinylidenfluoride). When non-weldable plastics are used, silicone or epoxy resin can be used as an adhesive.

The membranes used are preferably porous membranes, ultrafiltration or microfiltration membranes in particular, with pore sizes of 1 to 5000 nm, preferably 1 to 1000 nm, and most preferably from 5 to 800 nm.

The membranes are preferably composed of one of the following materials: cellulose ester, polyacrylonitrile, polyamide, polycarbonate, polyether, polyethersulphone, polyethylene, polypropylene, polysulphone, polytetrafluoroethylene, polyvinylalcohol, polyvinylchloride, polyvinylidenfluoride, regenerated cellulose, or aluminum oxide, silicon oxide, titanium oxide, zirconium oxide, as well as mixtures of ceramics consisting of the abovementioned oxides.

For the purpose of improved flow control in the module, spacers, which are equipped with grilles or netting, are preferably utilized in the concentrate and diluate chambers, but also in the electrode chambers. These installations finction as flow breakers and optimize the material transfer. These spacers are also attached to a sealing frame at their edges, and are permanently connected with the neighboring membranes to a module, which is equipped with the overflow channels.

The sealing frames can consist of plastic or a mixture of plastics, preferably thermoplastics, thermoplastic elastomers, or cured plastics. Examples are polyethylene, polypropylene; polyamide, ethylene-propylene-diene-polymethylene (EPDM), epoxy resin, silicone, polyurethane, and polyester resin.

The electrodes preferably consist of one or more of the following materials: metals such as e.g. platinum, palladium, gold, titanium, stainless steel, Hastelloy C, or metal oxides such as e.g. iridium oxide, graphite, or conductive ceramics. Useable electrode designs are flat models (foils, plates) and spatial models (webbing, grids, expanded metals, or bars). The electrodes' surface can be enlarged through coating methods, such as platination, for example.

The device contains constructions to allow continuous flow through the anode and cathode chambers. The cathode and anode chambers are preferably connected to independent circuits.

On an industrial scale, the device, which corresponds to the invention, consists preferably of two or more modules arranged in a stack, which are supplied by common channels. Two modules connected by a bi-directional holding plate are preferred, in which the modules contain channels for fluid distribution, which are at least connected to the input and output chambers of the modules.

Various electrode configurations are possible, even when the modules are connected by way of bi-directional holding plates. The electrodes can either be integrated into the separation modules or into the holding plates, or separate electrode modules can be used.

The device can be used for both batch operation and continuous operation.

Another subject of the invention is a process for performing membrane electrophoresis, particularly while using the device, which corresponds to the invention, in which loosened and/or dispersed substances are separated, preferably while using the invention-related device. In this process, the electrodes are continuously rinsed with electrode rinse solution, and the diluate is continuously directed through the diluate chamber or the concentrate is continuously directed through the concentrate chamber. In the process, at least one loosened or dispersed substance is electrophoretically transferred in the diluate between the diluate chamber and the concentrate chamber via an electric field located between the anode and cathode. The diluate flows past the separation membrane with a flow speed of at least 0.025 m/s, preferably from 0.05 to 0.5 m/s.

During electrophoresis, an electric double layer forms in the membrane pores, which leads to induction of an electroosmotic flow (Galier et al., J. Membr. Sci. 194 [2001] 117-133). Admitting pressure into the diluate or concentrate chamber can compensate for this effect, which can negatively affect the productivity and selectivity.

Another subject of the invention is a process for electrofiltration, particularly while using the device, which corresponds to the invention, in which loosened or dispersed substances are separated. During this process, the electrodes are continuously rinsed with electrode rinse solution, and the retentate is continuously directed through the retentate chamber or the permeate is continuously directed through the permeate chamber. In the process, loosened and/or dispersed substances in the retentate are separated by a pressure differential between the retentate chamber and permeate chamber, as well as by an electric field located between the anode and cathode, in which at least one loosened or dispersed substance in the retentate is transferred in a liquid, flow from the retentate chamber through the separation membrane to the concentrate chamber in such a way that the retentate flows past the separation membrane with a flow speed of at least 0.025 m/s, preferably from 0.05 to 0.5 m/s.

Due to its impermeability, the module can fundamentally be operated with high overflow. In order to minimize a convective flow through the separation membrane in the case of membrane electrophoresis or to guarantee a controlled convective flow in the case of electrofiltration, it is necessary to be able to keep the pressure differential constant between the individual chambers, particularly between the input and output chambers, over the length of the flow channels.

Supplying all channels from a common flow can solve this problem.

In order to minimize electrical short-circuits, anode and cathode chambers preferably have independent flows going through them.

The invention is suitable for purifying loosened or dispersed substances in aqueous media. Examples of use are the purification of proteins, peptides, DNA, RNA, oligonucleotides, plasmids, oligo- and polysaccharides, viruses, cells, and chiral molecules.

### BRIEF DESCRIPTION OF THE DRAWINGS

The invention is described in more detail on the basis of the figures below:

FIG. 1 Schematic representation of the invention-related module from above;

FIG. 2 Cross-section through the module in FIG. 1 along line A-A in FIG. 1;

FIG. 3 Spacer 5 seen from above;

FIG. 4 Spacer 6 seen from above;

FIG. 5 Spacer 21 seen from above;

FIG. 6 A section of the separation membrane 6 seen from above, corresponding to a section of a restriction membrane;

FIG. 7 An exploded view of the module in FIG. 1, shown in a quadruple stack arrangement;

FIG. 8 The state-of-the-art for electrophoresis and electrofiltration: a device consisting of individual membranes and spacers with netting, which is manually seared between two holding plates on location;

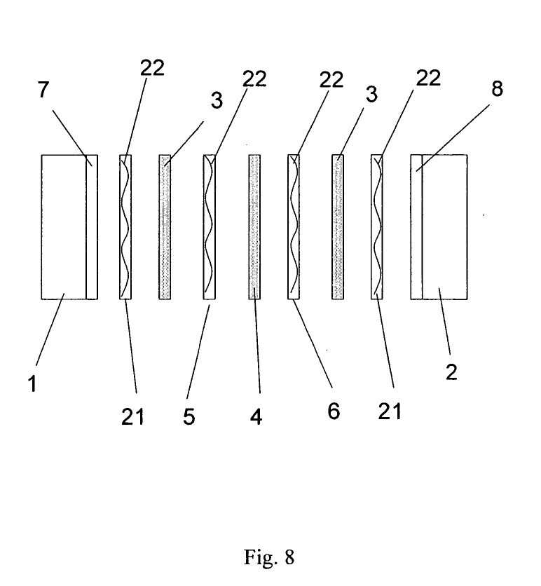

FIG. 9 A sketch of a device corresponding to the current invention with a permanently attached separation module, consisting of membranes, spacers, and netting, which can be sealed between holding plates. Inlets and outlets for input and output chambers, and for the electrode chambers, are integrated into the holding plates;

FIG. 10 A sketch of a device corresponding to the current invention with a permanently attached separation module as well as electrode modules, which can be jointly sealed between the holding plates. Inlets and outlets for input and output chambers, and for the electrode chambers, are integrated into the holding plates;

FIG. 11 A sketch of a device corresponding to the current invention with a permanently attached separation module, into which the electrodes are integrated. The module can be sealed between two holding plates. Inlets and outlets for input and output chambers, and for the electrode chambers, are integrated into the holding plates;

FIG. 12 A sketch of a device corresponding to the current invention with a permanently attached separation module, into which the electrodes and holding pates are integrated. The holding plates contain inlets and outlets for input and output chambers, as well as for the electrode chambers;

FIG. 13 A sketch of a device corresponding to the current invention as shown in FIG. 11 including a sealing frame with axial and radial projections;

FIG. 14 A schematic representation of modules connected in parallel by way of bi-directional holding plates; and

FIG. 15 An exploded view of a module shown in a double stack arrangement, which is suitable for connecting in the manner shown in FIG. 14.

It is understood that the references to the drawings herein are meant to be exemplary of the preferred embodiment(s) described herein, and that neither the drawings themselves, nor the reference numerals on the drawings are meant to be limiting of the invention in any respect.

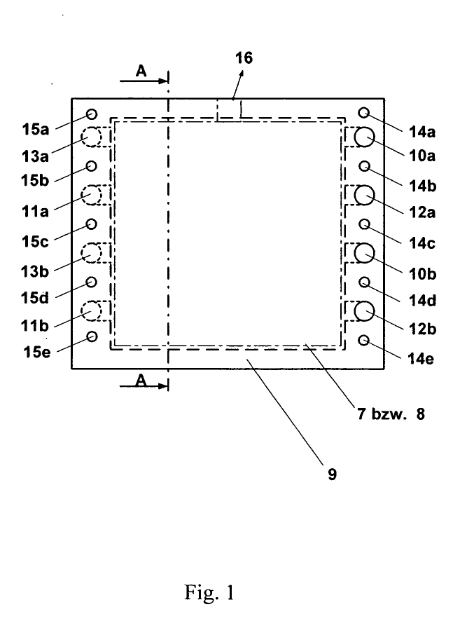

According to FIG. 1, the module corresponding to the invention is provided with inlets 10 a, b for the output chamber and inlets 12 a, b for the input chamber, as well as outlets 11 a, b for the output chamber and outlets 13 a, b for the input chamber. At the same time, inlets 14 a, b, c, d, e are present for feeding the electrode chambers, and the corresponding outlets 15 a, b, c, d, e are present on the top or bottom side. The solution fed into the system in this manner serves to rinse the electrodes 7,8. The input chamber, output chamber, and electrode chambers can be supplied with a common flow.

The voltage supply 16 for the electrodes can be laterally integrated on the module. The module body 9 is made of plastic and holds all utilized components in a leak-proof manner.

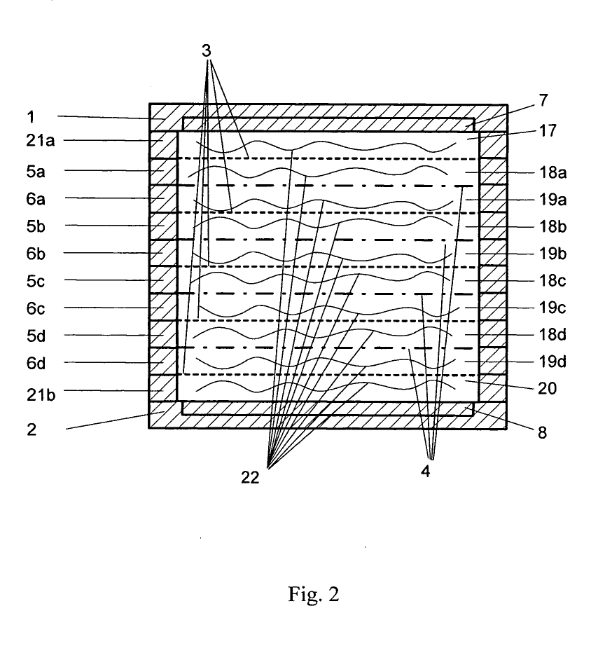

FIG. 2 shows a cross-section through one variation of the module in FIG. 1 along line A-A. This is a module that contains a membrane stack of four cell pairs, which are connected in parallel. The module contains an end plate 1,2 on the top and bottom sides, respectively, with integrated electrodes 7 and 8. The electrode chambers 17 and 20 are each formed by a frame gasket 21 a, b, and confined by a restriction membrane 3. Through the alternating arrangement of frame gasket 5a, b, c, d, separation membrane 4, frame gasket 6 a, b, c, d, and restriction membrane 3, a membrane stack is constructed. The input chambers 18 a, b, c, d and the output chambers 19 a, b, c, d are preferably connected in parallel. In FIG. 2, there is a sketch of a membrane stack consisting of four cell pairs, however embodiments with fewer or more cell pairs are possible as well. The utilized spacers 5 a, b, c, d and 6 a, b, c, d can be additionally equipped with netting or grilles 22.

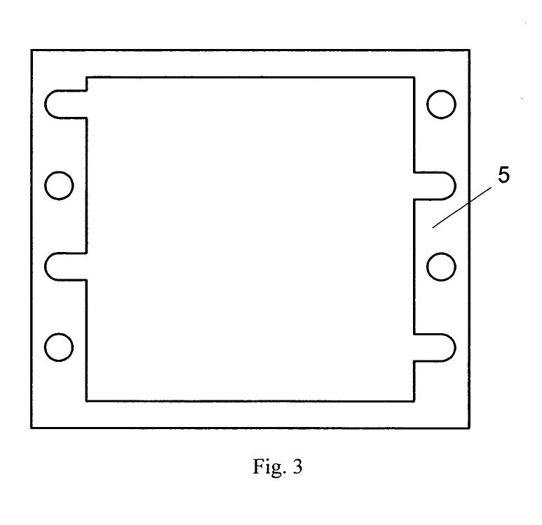

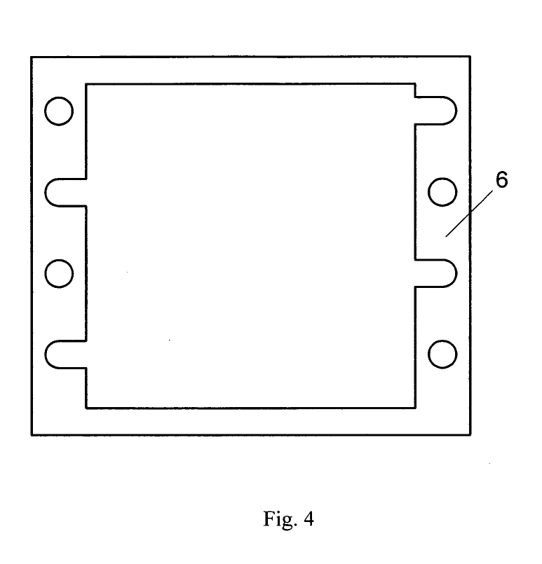

FIGS. 3 and 4 each show one variation of frame gaskets 5 and 6, which are used in order to connect the cell pairs of a membrane stack in parallel.

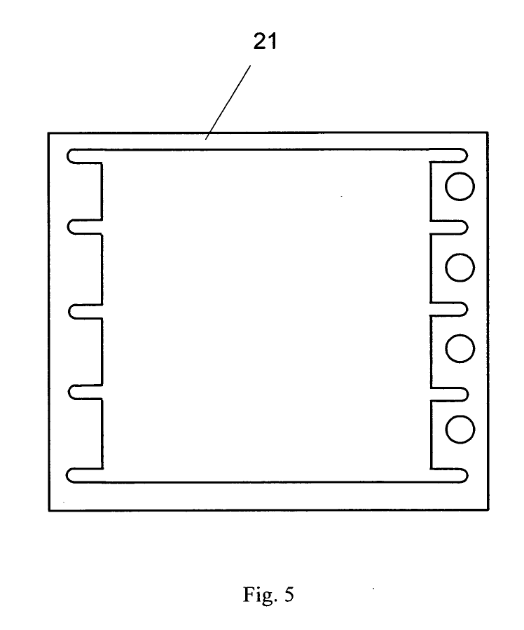

FIG. 5 shows a variation of frame gasket 21.

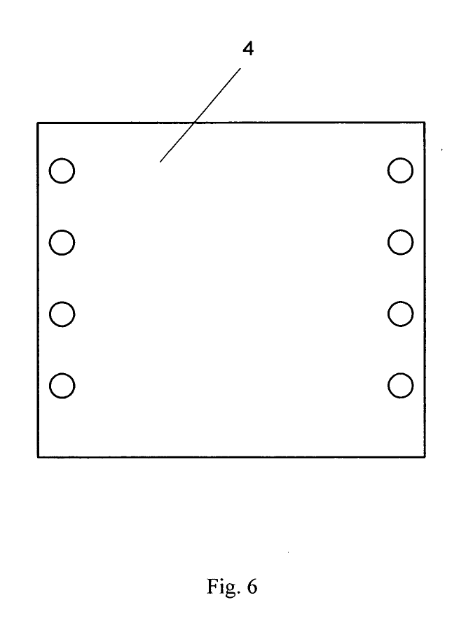

FIG. 6 shows a section of separation membrane 4 from above. This also corresponds to a section of restriction membrane 3.

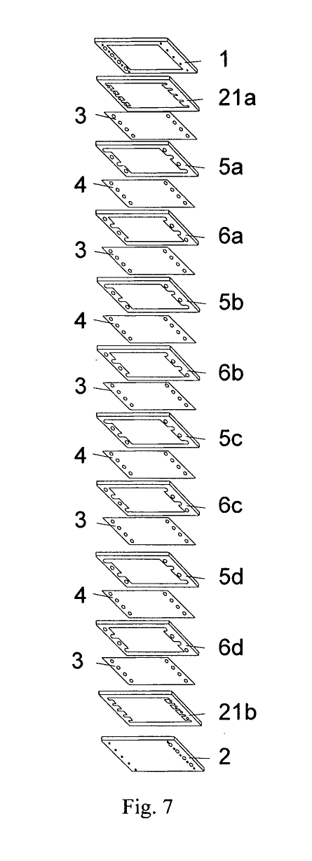

FIG. 7 shows the principle composition of the individual elements of one embodiment of the module corresponding to the present invention. The end plates 1 and 2 contain holes for flows into the electrode chambers as well as into the input and output chambers. The individual chambers are formed by the restriction membranes 3, the spacers 21 a, b, the spacers 5 a, b, c, d, the separation membranes 4, and the spacers 6 a, b, c, d.

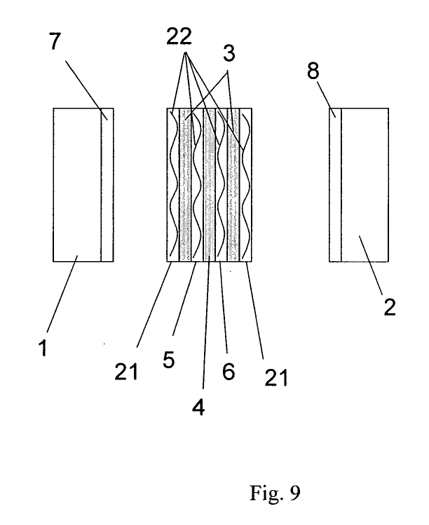

FIG. 9 schematically shows a device corresponding to the present invention with a permanently attached separation module consisting of membranes 3,4, spacers 21,5,6, and netting 22, which can be sealed between holding plates 1,2. Inlets and outlets for input and output chambers, and for the electrode chambers, are integrated into the holding plates. The module in FIG. 9 includes one input and one output chamber. A variation of the module, which contains a stack of several input chambers and output chambers in an alternating arrangement, is feasible as well.

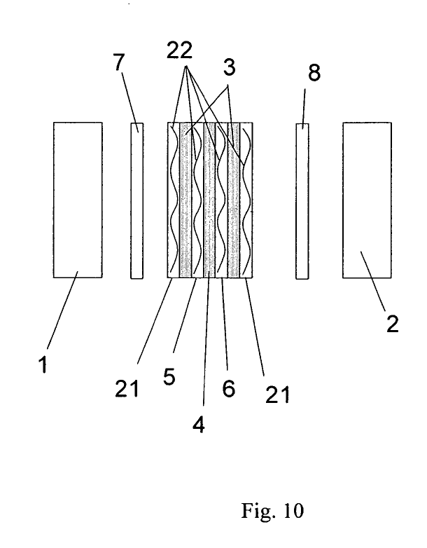

FIG. 10 schematically shows a device corresponding to the present invention with a permanently attached separation module consisting of membranes 3,4, spacers 21,5,6, and netting 22, as well as electrode modules including electrodes 7,8. The modules can be jointly sealed between holding plates 1,2. Inlets and outlets for input and output chambers, and for the electrode chambers, are integrated into the holding plates. The separation module described contains one input chamber and one output chamber. A variation of the module, which contains a stack of several input chambers and output chambers in an alternating arrangement, is feasible as well.

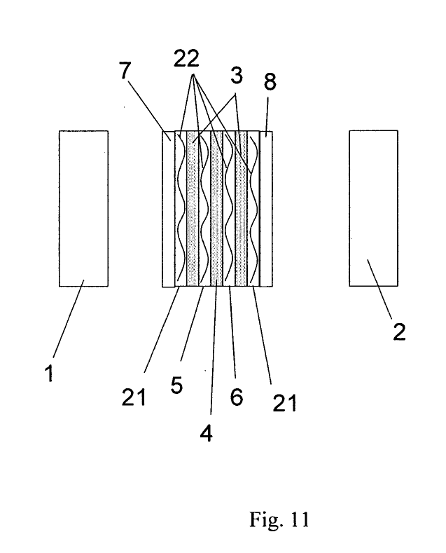

FIG. 11 schematically shows a device corresponding to the present invention with a permanently attached module consisting of membranes 3,4, spacers 21,5,6, netting 22, and electrodes 7,8. The module can be sealed between holding plates 1,2. Inlets and outlets for input and output chambers, and for the electrode chambers, are integrated into the holding plates. The separation module described contains one input chamber and one output chamber. A variation of the module, which contains a stack of several input chambers and output chambers in an alternating arrangement, is feasible as well.

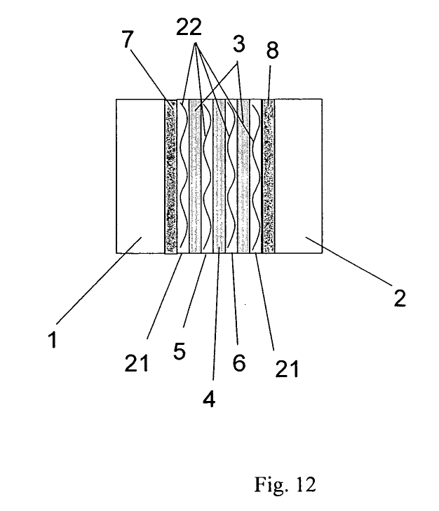

FIG. 12 schematically shows a device corresponding to the present invention with a permanently attached module consisting of membranes 3,4, spacers 21,5,6, netting 22, electrodes 7,8, and holding plates 1,2. The module is sealed in a leak-proof manner and does not require any additional internal assembly. Inlets and outlets for input and output chambers, and for the electrode chambers, are integrated into the holding plates. The separation module described contains one input chamber and one output chamber. A variation of the module, which contains a stack of several input chambers and output chambers in an alternating arrangement, is feasible as well.

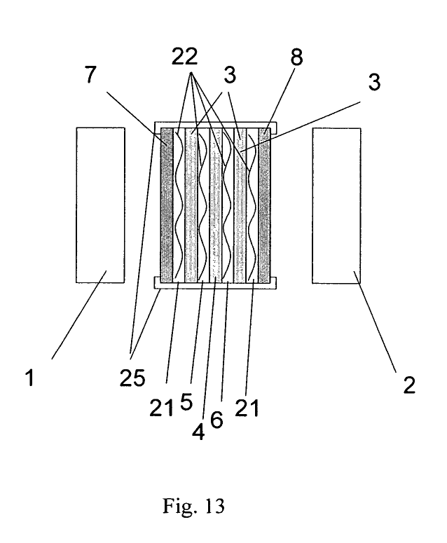

FIG. 13 schematically shows a device corresponding to the present invention with a permanently attached module according to FIG. 11. In this sketch, an additional sealing frame 25 is included with a radial and axial projection.

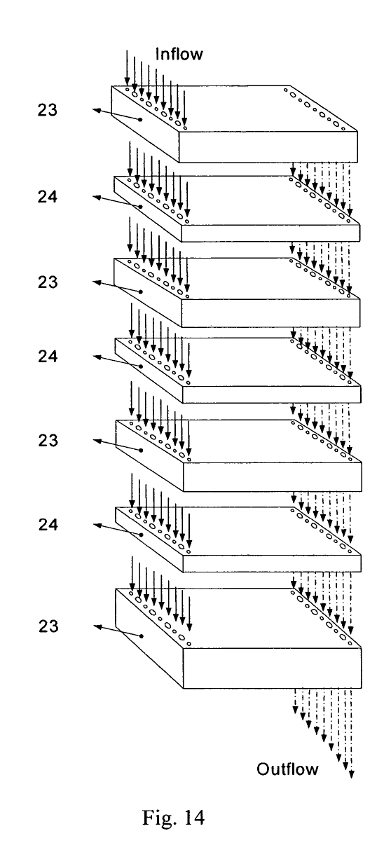

FIG. 14 schematically shows the parallel connection of several modules 23 by way of bi-directional holding plates 24.

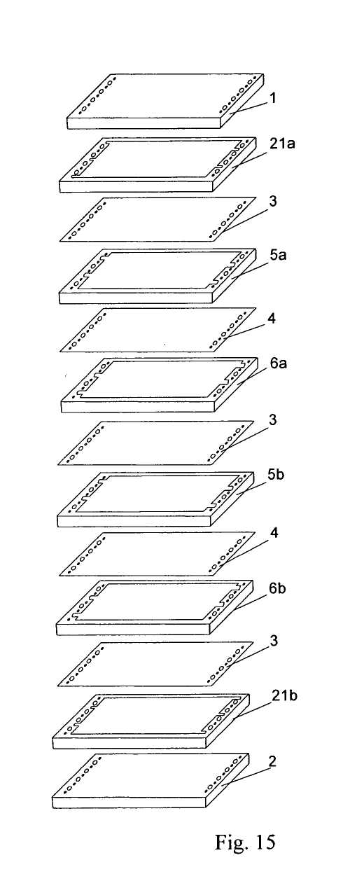

FIG. 15 shows an exploded view of a module in a double stack arrangement, consisting of end plates 1,2, membranes 3,4, and spacers 5 a, b; 6 a, b; and 21 a, b. The electrodes are integrated into the end plates. The module is suitable for parallel connection using bipolar holding plates, according to FIG. 14.

It should be understood that the preceding is merely a detailed description of one preferred embodiment or of a small number of preferred embodiments of the present invention and that numerous changes to the disclosed embodiment(s) can be made in accordance with the disclosure herein without departing from the spirit or scope of the invention. The preceding description, therefore, is not meant to limit the scope of the invention in any respect. Rather, the scope of the invention is to be determined only by the appended issued claims and their equivalents.

1. Device for membrane electrophoresis or electrofiltration comprising at least a first holding plate, a first electrode chamber with a first electrode, at least one input and one output chamber, a second electrode chamber with a second electrode, and a second holding plate, in which the chambers are separated from one another by flat membrane sections, and in which at least the edges of the membranes are integrated into a sealing frame in a permanently attached module, and the sealing frame possesses channels for the inflow and outflow of liquids with holes leading off the channels into selected chambers, and in which connecting channels are present in at least one of the holding plates, which correspond to the respective channels in the sealing frame.

2. Device according to claim 1, in which several input and output chambers are arranged in the module in alternating order, and in which input chambers and output chambers are optionally connected in parallel.

3. Device according to claim 1, in which one or both of the electrodes consist of a flat section of an electrode material, the edges of which are permanently attached between a sealing frame and a separately exchangeable electrode module.

4. Device according to claim 1, in which one or both electrodes consist of a flat section of electrode material, the edges of which are integrated into the sealing frame in a permanently attached module, along with the membranes.

5. Device according to claim 4, in which one or both holding plates are permanently integrated into the module.

6. Device according to claim 1, in which the sealing frame exhibits a radial and axial plastic projection over the flat membrane sections.

7. Device according to claim 6, in which the axial projection amounts to less than 100 μm, and forms an edge seal using contact pressure.

8. Device according to claim 1, wherein the flat membrane sections comprise porous membranes with pore sizes from 1 to 5000 nm.

9. Device according to claim 8, wherein the porous membranes consist of one of the materials selected from the group consisting of cellulose ester, polyacrylonitrile, polyamide, polycarbonate, polyether, polyethersulfone, polyethylene, polypropylene, polysulfone, polytetrafluoroethylene, polyvinylalcohol, polyvinylchloride, polyvinylidenfluoride, regenerated cellulose, aluminum oxide, silicon oxide, titanium oxide, zirconium oxide, and mixtures of ceramics consisting of the abovementioned oxides.

10. Device according to claim 1, wherein the first electrode chamber and the second electrode chamber are connected to circuits independently of one another.

11. Device according to claim 1, wherein several modules are connected by way of bi-directional holding plates, in which the bi-directional holding plates contain channels for fluid distribution, which are at least connected to the input and output chambers of the modules.

12. Process for membrane electrophoresis of loosened or dispersed substances, using a device according to claim 1, comprising continuously rinsing the electrodes with electrode rinse solution, and continuously directing a diluate through the input chamber or continuously directing a concentrate through the output chamber, wherein at least one loosened or dispersed substance in the diluate is electrophoretically transferred from the input chamber to the output chamber by means of an electric field located between the first electrode and the second electrode, in such a way that the diluate flows past the separating membrane with a flow speed of at least 0.025 m/s.

13. The process according to claim 12, wherein the flow speed is from 0.05 to 0.5 m/s.

14. Process for electrofiltration of loosened or dispersed substances, using a device according to claim 1, comprising continuously rinsing the electrodes with electrode rinse solution, and continuously directing a retentate through the input chamber or continuously directing a permeate through the output chamber, wherein loosened or dispersed substances in the retentate are separated by means of a pressure differential between the input chamber and the output chamber, as well as by means of an electric field located between the first electrode and the second electrode, in which loosened or dispersed substances in the retentate are transferred from the input chamber through the separating membrane to the output chamber in a liquid flow, in such a way that the retentate flows past the separating membrane with a flow speed of at least 0.025 m/s.

15. The process according to claim 14, wherein the flow speed is from 0.05 to 0.5 m/s.

16. Process according to claim 12, in which the input chamber, output chamber, and optionally the electrode chambers are supplied from a common flow source.

17. Process according to claim 14, in which the input chamber, output chamber, and optionally the electrode chambers are supplied from a common flow source.
